(19) United States
(12) Patent Application Publication
(10) Pub. No.: US 2022/0051323 A1
(43) Pub. Date: Feb. 17, 2022

(54) ISLAMIC FINANCIAL OPTIONS

(71) Applicant: Sherif Fathy Abdelmonem ELZANATI, Hawally (KW)

(72) Inventor: Sherif Fathy Abdelmonem ELZANATI, Hawally (KW)

(21) Appl. No.: 17/293,560

(22) PCT Filed: Nov. 12, 2019
(86) PCT No.: PCT/IB2019/059687

§ 371 Date: May 13, 2021

(30) Foreign Application Priority Data
Nov. 20, 2018 (TR) 2018/17513U

(51) Int. Cl. G06Q 40/04

(52) U.S. Cl. CPC G06Q 40/04

(57) ABSTRACT

The Islamic Financial Options are true financial instruments contracts, where one party sells the other specific assets at an agreed upon price, delivery of price and assets take place during an agreed upon timeframe, the financial instrument comes in two specific types, Call option and Put Option; each type has specially designed terms and conditions to function like financial options in the hands of the parties, while maintaining the compliance with the Islamic Sharea rules. Options are an essential risk management tool; conventional options are disallowed by the Islamic Sharea due to separating the ability to enforce selling or buying the underlying assets from the original sale contract, forming a derivative standalone contract which is traded as a financial instrument; the practice of separating specific rights from the original whole sale contract is noncompliant with the Islamic Sharea.

### INTRODUCTION

Investors need to preserve the value of their financial assets, conventional options are an important tool to offset the effects of volatility of the market values; Islamic Financial Options are a new instrument that enable Islamic Sharea compliant investors achieve managing risks as not previously possible due to inability to utilize conventional options.

While Conventional options are disallowed as a means, their objectives of risk management are not; Islamic Financial Options are an Islamic substitute of the conventional options, designed to achieve the objectives of risk management and even speculation, which both were previously unattainable by means of any Islamic Sharea compliant financial instrument.

Conventional Options are contracts signed between two parties, one is the seller of the option and the purchaser of the option, the sold option can be a put option, or a Call option, a put option enables the purchaser (holder) of the option to purchase an agreed upon number of shares at a specific price mentioned in the contract; the Put option enables the purchaser (holder) of the option to sell an agreed upon number of shares at a specific price during an agreed upon timeframe which is the life span of the option contract.

Conventional options separate the right to buy or sell the specified shares in a standalone contract, i.e. there is no a commitment to buy or sell these shares by the option holder, the sale or purchase transaction exists only if the option holder exercises the contract, otherwise, the contract does not commit the holder or the seller to execute the transaction. This right to sell/buy is stated in the conventional option contract, so the contract contains no commitment for both the parties, only one party would be committed to sell, and only if the other party opts to exercises the contract. Conventional options contracts are traded at nominal prices, and are used for risk management (the risk here is the decline in the shares market price, so in the hands of option holder they represent an insurance against decline in value of shares they want to preserve their value)

Conventional financial options are disallowed by Islamic sharea, due to separating the specific right to buy or sell some assets in a stand-alone contract (option contract) that holds one party obliged but not the other, enabling the option holder to buy or sell those specific assets at agreed upon contract prices, also, the option seller in most of the cases may not own the assets nominated in the option contract.

The IFO is the very contrary to the conventional option, there exists a committing sale transaction for the two parties, this is why it is a real contract, that has an option to revoke the whole contract.

The timed rights enable the parties to tailor the behavior of the contract in their hands to act like the conventional options, accordingly, the objectives of the risk management and speculation could be reached.

The IFO Instrument is a hybrid instrument that introduces a new relationship between its parties, due to the inclusion of inventive features, so the instrument achieves the intended objectives.

### EXPLANATION AND STRUCTURE OF THE ISLAMIC FINANCIAL OPTION CONTRACT

Islamic Financial Options are a new innovative financial instrument which achieves the objectives of conventional financial options and comply with the Islamic Sharea, through a single contract. Islamic Financial Options come in two forms, Call or Put Options.

As a rule in the Islamic Shariya's jurisprudence of financial dealings “Fiqh Almoaamalat”, all Islamic compliant dealings must include a transaction of real economic exchange, essentially a Sale transaction; being a sale of a tangible asset, a service or a usufruct or utility (leasing); variation in the nature of the sold commodity mandate differences in the manner and timeframe of delivery of the assets or prices, and consequently the mechanisms or conditions to protect the rights of the parties.

Islamic compliant products are the Salam, Istisna'a, Murabaha, Tawarroq and Ijarrah (lease) all include a sale transaction, but their contracts differ to preserve the rights of the parties due to varying circumstances; here, the method of doing business is the “sale” of assets or usufruct, the contract is the instrument that regulates the relationship between the parties to preserve their rights.

Innovative Islamic Compliant products can't escape this rule and should follow the same pattern to remain compliant with the Islamic Sharea, accordingly, the Islamic Financial Options instrument contract includes a sale transaction, however, no inventiveness related to the sale process or the investing activity, the inventiveness relates to the other rights given to the parties, these conditions together enable the whole instrument to behave like conventional options. Maintaining the compliance with the Islamic Sharea necessitates existence of the sale transaction

The IFO instrument contract includes the essential sale transaction, and some essential terms which deploy the novel Timed Rights (Explained Later) to achieve the same goals as the Conventional Options through a real contract that complies with Islamic Sharea.

The special essential terms and conditions of the instrument contract are as follows;
1—Payment of a Premium, the purchaser should pay a small percentage of the full price upon signing the instrument contract; this condition is necessary so the instrument maintains compliance with the Islamic Sharea.
2—Timed right of Postponement of Delivery of the assets and the remainder of the price; delivery of the sold assets and the price remainder are postponed for an agreed upon period that is at maximum one day shorter than the instrument's life span. On the last day of the instrument, delivery becomes mandatory on both parties unless the contract was revoked. This condition is applicable for both parties.
3—Assignment; each party of the instrument contract can assign his position in the contract to a third party without notice to or consent of the other party, i.e. the contact is assignable.
4—Timed right to revoke the contract; this right gives its holder the unilateral power to revoke the contract during a determined agreed timeframe/interval that is at maximum one day shorter than the contract life span; the timed revocation right is given to only one of the parties not both. This right is critical and gives the instrument the “option” characteristics; the party who has the Timed Revocation right is the option holder and that determines the option type (Call or Put).
5—Timed right to Decline Delivery of assets or payment of price remainder, this right enables its holder to refuse delivery of his part, during a determined agreed timeframe/interval shorter than and falling within the contract life span. This right can be given to both parties simultaneously.
6—Timed right to tender Payment/Delivery and enforce effecting the contract, this right gives its holder the power to enforce the other party to execute his part of the contract on the time selected by the right holder without the other party being able to deny execution during a determined agreed timeframe/interval shorter than and falling within the contract life span. This timed right conies in consecution of the timed right to decline delivery (condition 5 above), both rights can't be given in to the same holder in simultaneous timeframes/intervals during the contract life span.

Every Islamic Financial Option instrument contract must include all these conditions; the distribution of the rights between the parties determines the option type, while in general, the party holding the Timed Revocation right becomes the “option” holder.

The feature of “Timed Rights”: this concept is to establishing a condition that gives one or both of the parties the power to exercise a specific right during an agreed upon timeframe/interval that is shorter than the whole life span of the contract and falls within it, once the timeframe ends, the right holder can't exercise that right any longer during the contract life.

The innovativeness of the IVO Instrument comes from the following features
1—inclusion of “Timed Rights” a feature which allows or restricts use of the right given to its holder during a specific agreed upon timeframe within the whole life span of the contract. Timed rights is a feature that has never been used in financial instruments.
2—The Islamic Financial Options are real contacts, not derivative contracts, so, calculating the market value becomes determinable through deploying the conventional valuation methods and models, unlike derivatives which use valuation methods depending on creating similar portfolios that produce the same yield to determine the exchange value of the instrument. A feature that enables to determine the value of the contract with more precision.
3—Formulating an Islamic compliant financial option in one single instrument of a real contract has not been previously achieved; the IFO contract includes the “Option” characteristics within the contract terms, so, non-revocation of the contract becomes exercising the call/put option, which means that the option contract is a complete one, which is unlike the conventional financial options, previous attempts failed to create a single instrument that constitutes the option contract through a real contract, due to inability to comply with the Islamic sharea and still maintain the function of conventional the options.
The above invokes use of new accounting treatment and presenting the Islamic Financial Options as a financial instrument; due to that the transaction is conclusive, the accounting records would show straight forwardly the transfer of title of the sold assets to the purchaser, eliminating the need to use conventional derivatives accounting treatments. Despite being a real financial contract, the initial investment needed to enter this contract is nominal (an advantage of derivatives over real financial instruments contracts) while delivering the same protection against risks as the conventional options.
4—The use of the presented financial instrument can be easily deployed for any type of assets, not only shares (which are used in the example here). Any asset that has a fluctuating market price pattern can be the underlying asset for the instrument of Islamic Financial Options. Opening the door for commodities trading (but not yet adequately explored).

### ESSENTIAL EXPLANATIONS

### The Nature of Innovative Mechanisms Deployed in the IFO Instrument (Being Not Processes):

The IFO contract introduces a new concept of enabling rights to its parties, called Timed Rights; allowing the right holder to exercise to exercise a specific right only during an interval of time within the contract life.

The contract has a life span which is reasonably long to allow timed rights to exist in consecution or simultaneously be granted for the parties, depending on the intended type of option.

The timed rights are not processes or steps that are performed, they are mechanisms that enable the holder a privileged position or benefit which be can utilize during the allowed timeframe; the holder can exercise these rights or let the timeframe pass without exercising the right, according to his own discretion.

The inventive timed rights exist in a contingent mode to be exercised only if the right holder desires to, otherwise, the mechanisms are not deployed, so they are optional to be deployed, not necessarily deployed for the instrument to bring its effect.

These inventive timed rights are mechanisms which do not constitute an investing or trading steps, and can't exist in a stand-alone in a separate instrument that would have a value to its parties.

How the IFO Contract Differs from Conventional Options Contracts

Conventional Options are contracts signed between two parties, one is the seller of the option and the purchaser of the option, the sold option can be a put option, or a Call option, a put option enable the purchaser of the option to purchase an agreed upon number of shares at a specific price mentions in the contract; the Put option enables the purchaser of the option to sell an agreed upon number of shares at a specific price during an agreed upon timeframe which is the life span of the option contract.

The conventional options separate the right to buy or sell the specified shares in a standalone contract, which is traded at a nominal value i.e. there does not exist a committing sale transaction between the parties, only a conditional transaction (only if the option holder exercises the contract, otherwise, there is no transaction committed by the parties), the right to sell is stated in the contract, so the contract is called a derivative contract because it contains no committing duties to the parties, one is committed to sell if the other party exercises the option.

The IFO is the very contrary to the conventional option, there exists a committing sale transaction to the two parties, this is why it is a real contract not a derivative one, and the option is to revoke the whole contract (the committing sale transaction).

The timed rights enable the parties to tailor the behavior of the contract in their hands to act like the conventional options, accordingly, the objectives of the risk management and speculation could be reached.

The IFO Instrument is a hybrid instrument that introduces a new relationship between its parties, due to the inclusion of inventive mechanisms, so the instrument provides for intended purposes, the composition of the instrument provides for by-the-definition a Financial Instrument.

### THE CLAIMS IN THE IFO APPLICATION

As previously explained, the IFO contract is a whole contract that constitutes the instrument contract and can't exclude the sale transaction from within its essential building blocks, along with the inventive timed conditions; accordingly, the Claims have to include the sale transaction and the innovative timed conditions.

FIG. 1 shows how timed conditions duration as deployed in the Instrument.

The Whole life span of the Contract

| First Day | | | | | | | | | | | | | |
|---|---|---|---|---|---|---|---|---|---|---|---|---|---|
| Jan. 1, | | | | | | | | | | | | | Last Day |
| 2014 | January | February | March | April | May | June | July | August | September | October | November | December | Dec. 31, 2014 |

| | | | |
|---|---|---|---|
| Parties | The first three months | The rest of the instrument life span where the | The contract |
| sign | the right of decline to | timed revocation holder can revoke the contract. | must be |
| contract. | deliver is enacted. | (Seller in Put Option, Purchaser in call Options) | performed, |
| 2- The | 5- Right to decline | 5- Right to tender delivery of his own part | i.e. the seller |
| purchaser | delivery, | and enforce the other party's part:. | must deliver |
| pays | | | the assets |
| advance | | | and |
| payment- | | | purchaser |
| 5% of the | | | must pay the |
| prices. | | | remainder of |
| Delivery | | | the price. |
| of assets | | | (Unless it |
| and rest | | | was |
| of the | | | previously |
| price are | | | revoked by |
| postponed | | | the timed |
| till the last | | | revocation |
| day of the | | | right holder) |
| instrument | | | |
| life span | | | |
| (Dec., 30, | | | |
| 2014) | | | |

3- Postponement of delivery could delayed till one day before the contract life span ends.
4- Right to assign role and position to third parties without other party consent (not during last day)
6- Right to revoke contract (less one day than contract life)

Illustration of the “Islamic Financial Option” instrument contract in its two types.

| Islamic Call option Instrument Contract | |
|---|---|
| On Jan. 1, 2014 the two parties agreed on | |
| the following:- | |
| 1. | A party Sells assets (1000 Shares) to B |
| | party for 1$ per share. |
| 2 | B Party pays 5% of the price upon |
| | signing the contract. |
| 3. | The assets will be delivered during a |
| | timeframe till Dec. 30, 2014. (the |
| | contract ends Dec. 31, 2014) |
| 4. | The parties are free to assign their |
| | positions in the contract for third |
| | parties without the preapproval of the |
| | other party. |
| 5. | A (the seller) has the right to decline |
| | delivery during the first 3 months after |
| | signing the contract. |
| 6. | B (the purchaser) has the right to |
| | revoke the whole contract anytime |
| | during its life less one day - i.e. up till |
| | 30 Dec. 2014 |
| 7. | B has the right to tender payment and |
| | enforce delivery of assets to him. |
| | Islamic Put option instrument Contract |
| | On Jan. 1, 2014 the two parties agreed on |
| | the following:- |
| 1. | A Sells assets (1000 Shares) to B for 1$ |
| | per share. |
| 2. | B Party pays 5% of the price upon |
| | signing the contract. |
| 3. | The assets will be delivered during a |
| | timeframe till Dec. 30, 2014. (the |
| | contract ends Dec. 31, 2014) |
| 4. | The parties are free to assign their |
| | positions in the contract for third |
| | parties without the preapproval of the |
| | other party. |
| 5. | A (the seller) has the right to Decline |
| | delivery during the first 3 months |
| | following signing the contract. |
| 6. | A (the seller) has the right to |
| | unilaterally revoke the whole contract |
| | anytime during its life less one day - i.e. |
| | up till 30 Dec. 2014 |
| 7. | A (the seller) has the right to tender |
| | delivery of the shares during the life of |
| | the contract. (the purchaser is obliged |
| | to deliver the price and receive shares) |

The conditions and terms of the instrument can't be changed by the parties, after it is registered by the authorities, otherwise the instrument deviates from its objective and would not perform as an option contract.

The coloring of each condition timeframe in the table is used to highlight the corresponding condition in the written illustration of the instrument contract.

### Implementation of the Islamic Financial Options:

Islamic Financial Options are financial instruments, which encompass an agreement between two parties, where one party has a privileged position; so, in order to preserve the market integrity, such contractual agreement needs to be registered and monitored by the authorities or an independent trusted party.

A software application becomes an integral part of the invention; the software serves as the implementation and monitoring tool. The software processes the data to produce and project the updated positions of the parties based on their actions and decisions.

The Software application should be running on a dedicated server, which includes the application and the database of the clients' information and historical data of the transactions. The server is located in a secure place within the control of the authorities.

The software could be connected to a mail application through which official communications are sent to the parties to inform them of the actions of the other party and report them the changes in their positions based on the other party's actions.

Access to the software should be principally maintained by the financial authorities, the IFO contract parties are required to inform the authorities by their decisions through an officially agreed upon communication means to be registered and acknowledged to the other party in the due time; the use of the software should be indicated in the contract to be the official platform where the positions and actions of the parties are registered and disclosed to each other.

The function of the software begins right after signing the IFO contract; specific forms/screens are used to register the initial information and rights of each party as indicated in the contract.

The initial information to be registered upon initiating the agreement include the following:
1—Reference code or number of the contract as a unique identification for the contract.
2.—Registration date and the contract date (may be different)
3—Registering the shares sold, identifying the shares, their quantity, and their total sale price.
4—The advance payment paid by the purchaser.
5—The remaining price, and the ultimate date of payment.
6—The entire contract life, to indicate shares and the remainder of the price delivery dates.
7—The timed rights conditions timeframes,
8—The right to decline delivery of assets and price for each party
9—The right to revoke the contract (stretches takes the entire life of the contract assigned to one of the parties only)
10—The right to tender payment/price remainder, this right is assigned to one of the parties only, and starts after the right to decline delivery condition timeframe ends—no overlapping of periods is allowed.
11—Right to assign the contract without the other party's consent.
12—Acceptance of the software as the official platform to disclose execution of rights and source of information of the other party's actions.

The source of this information is the contract document, copy of which should be delivered to the authorities as a reference to support the transaction.

The software application will create an account for each party where their position is presented in reference to the contract.

### The Functions Performed by the Software

Upon completing the registration of the initial information, the software sends alerts to the parties to inform them of their positions and to indicate the relevant dates and deadlines, showing payment of the advance payment and the stating the applicable rights of each party in the current timeframe.

During the life of the contract the software performs the functions indicated in the presented scenarios, as the functions depend on the actions of the parties which are determined by the market conditions as will be indicated.

The steps of implementing the invention are indicated as follows:

In the presented implementation example, there are constant information which relate to f the sale transaction in the instrument contract, which remain unchanged across the options types and scenarios; there are also the essential special terms and conditions which formulate the required type of the option; the scenarios indicate the shares' Market Value movement in comparison to the contract price, thus the actions of the parties are determined.

### The Constant Information

A & B entered the Islamic Financial Option Contract with the following terms:

On Jan. 1, 2014, “A” the Seller, sells 1000 shares for $1/share to “B” the purchaser; the sale price is determined regardless of the actual shares' market value on the contract date.
“B” paid $100 upon signing the contract, as part of the price.
“B” the Purchaser has become indebted to “A” by $900.
The contract life is One year, starts Jan. 1, 2014, till Dec. 31, 2014
Both parties have the right to assign their rights/positions in the contract to any third party any time during the contract life without the consent of the other party.

The contractual sale price is determined regardless of the actual shares' market value on the contract date.

These information are registered on the software (point 1 to 12 above), to determine the positions of each parties; these information represent the basic information of the sale transaction.

The special conditions which determine the type of the option are to be registered according to the following:

### To Formulate an Islamic Call Option

Note: A call option is a one that enables its holder the right to purchase shares at the option price; in Islamic Financial Options version, it is the purchaser's right to enforce the transaction at the contractual price.

The two parties should agree on the following Special essential conditions to formulate the call option:
1—A (the seller) has the right to decline delivery during the first 3 months after signing the contract.
2—B (the purchaser) has the right to revoke the whole contract anytime during its life less one day—i.e. up till 30 Dec. 2014
3—B has the option to tender payment and enforce delivery of assets to him.

These conditions are registered in the software application in a special form, the application assigns the timed rights and their timeframes to the relevant parties, the software automatically sends communications and alerts to the parties to inform them of the timed rights timeframes beginning and ending dates.

The contract life can be viewed as divided into three terms periods, which the software application indicates:
1—The first term; the first three months following signing the contract, where the Seller has the right to decline delivery.
2—The second term is the period that follows the first term till one day before the end date of the contract, April 1^{st} till Dec. 30.
3—The third term is the last day, where the two parties are obliged to execute the contract, unless the purchaser B has revoked the contract.

During the life of the contract the shares price fluctuates, the following scenarios indicate the parties' behavior in presumed market conditions.

The following scenarios indicate the Market Value changes and the parties' reactions.

### Scenario 1

The shares' market value declines below the contractual sale price during the second term, the period April 1^{st} till December 30 the following actions are expected from the Purchaser
a—The purchaser B keeps the shares with the seller on the hope that their MV will rise later during the second term.
b—On the day 30 Dec. 2014, the purchaser revokes the contract, and loses the $100 paid upon signing the contract.

This results in the following:
1—The seller earns the $100 as net profit from the transaction. (A typical position of option writer)
2—During the contract life, the Purchaser had the right to execute the contract if it was profitable, and avoid execution if it causes him loss, and has locked his loss to the $100. (A typical position of a call option holder)
3—The seller had a guaranteed value of his shares during the contract life.

Revocation is as letting the “Call Option” to expire.

The revocation is reported to the authorities and acknowledged to the other party through the official communication means, the software performs the following tasks:
1—Produce an official notification to the seller that the purchaser will revoke the contract, and that the transaction is not to be completed.
2—Calculating each party's position based on the revocation,
3—Then, statements of the settlement of each party's obligation to the other, no exchange takes place in this case.
4—The reports are communicated to each party through the communication software.
5—The application closes each party's position.

Based on the entered information the software application closes the transaction.

### Scenario 2

The Shares' Market Value rises above the Contractual Price during the second term, April 1^{st} till Dec. 30, 2014.
1—The Purchaser tenders payment of the price remainder and receives the shares. (A typical call option in the hands of purchaser)
2—The seller will be obliged to deliver the shares. (A typical position of a call option writer)

Not revoking the contract by the purchaser, produces the effect of a call option in the hands of the Purchaser.

The will to execute the contract is reported to the authorities and acknowledged to other party through the official communication means, the software performs the following tasks:
1—Produce official notification to the purchaser that the seller (as the revocation right holder) will not revoke the contract and that the purchaser is obliged to deliver the remainder of the price on the due date, and that the purchaser will receive the shares in return,
2—The calculations to report each party's position based on the above.
3—Then, statements of the settlement of each party's obligation to the other, delivery of shares and the remainder of the price.
4—The reports are communicated to each party through the communication software.
5—The application closes each party's position upon settlement of the dues.

Based on the entered information the software application closes the transaction, and produces reports on this as required by the authorities.

### To Formulate an Islamic Put Option

Note: A put option is a one that enables its holder the right to sell assets at the option price; in Islamic Financial Options version, it is should always be the seller's right to enforce the sale at the contractual price.

As real sale contracts, the Islamic Put options necessitate ownership of an asset before selling it, therefore, only the seller party can be the holder of the put option. There is no such case that an investor buys an Islamic put option that enables him sell specific assets which he does not already own; this is one material difference between the conventional options and options.

### The Constant Information

A & B entered the Islamic Financial Option Contract with the following terms:

On Jan. 1, 2014, “A” the Seller, sells 1000 shares for $1/share to “B” the purchaser; the sale price is determined regardless of the actual shares' market value on the contract date.
“B” paid $100 upon signing the contract as part of the price.
“B” the Purchaser has become indebted to “A” by $900.
The contract life is One year, starts Jan. 1, 2014, till Dec. 31, 2014
Both parties have the right to assign their rights/positions in the contract to any third party any time during the contract life without the consent of the other party.

The two parties should agree on the following Special essential conditions to formulate the put option:
1—A (the seller) has the right to Decline delivery during the first 3 months following signing the contract.
2—A (the seller) has the right to unilaterally revoke the whole contract anytime during its life less one day i.e. up till 30 Dec. 2014
3—A (the seller) has the right to tender delivery of the shares during the life of the contract. (the purchaser is obliged to deliver the price and receive shares)

These conditions are registered in the software application in a special form that makes the option act like a call option, the application determines the rights and their timeframes, the software enables sending alerts to the parties to inform them of the timeframes of the timed rights begin and end.

### Discussion

The share contract price in the put option tends to be slightly lower than its Market Value; this enables the seller to be entitled to have privileged relationship in the contract; hoping that the share price would fall below the contract price; the purchaser would normally enter into such contracts to take a required position.

During the life of the contract the share price fluctuates, the following scenarios indicate the parties' behavior in presumed market conditions.

The scenarios indicate the Market Value changes and the parties' reactions.

### Scenario 3

The MV of the share remains above the Contract Price, the parties act as follows:
1—The seller declines delivery of the shares during the first term, and revokes the contract during the second term to avoid loss.
2.—The Purchaser tenders payment to receive the shares after the first term, which results in that the seller revokes the contract.

Revocation is as letting the put option expire.

In this case, the two parties have entered into the contract to merely take specific positions as a risk management measure.

The revocation is reported to the authorities and acknowledged to the other party through the official communication means, the software performs the following tasks:
1—Produce an official notification to the seller that the purchaser will revoke the contract, and that the transaction is not to be completed.
2—Calculating each party's position based on the revocation.
3—Then, statements of the settlement of each party's obligation to the other, no exchange takes place in this case.
4—The reports are communicated to each party through the communication software.
5—The application closes each party's position.

Based on the entered information the software application closes the transaction.

### Scenario 4

The Market Value of the share declines below the Contract price.
1—A (the seller) will tender delivery of shares during the second term of the contract and will collect the contract price, which is higher than the Market Value. (A typical put option position holder)

Not revoking the contract and by the seller, produces the effect of a put option in the hands of the seller.

The will to execute the contract is reported to the authorities and acknowledged to other pa through the official communication means, the software performs the following tasks:
1—Produce official notification to the purchaser that the seller (as the revocation right holder) will not revoke the contract and that the purchaser is obliged to deliver the remainder of the price on the due date, and that the purchaser will receive the shares in return.
2—The calculations to report each party's position based on the above.
3—Then, statements of the settlement of each party's obligation to the other, delivery of shares and the remainder of the price.
4—The reports are communicated to each party through the communication software.
5—The application closes each party's position upon settlement of the dues.

Based on the entered information the software application closes the transaction, and produces reports on this as required by the authorities.

The parties' behavior is governed by their objectives of speculation and risk management.

Necessary Issues to be Considered upon Applying the Invention in the Real World.

In the Islamic Sharea, a sale transaction is not eligible without first owning the property subject to sale; short sale of assets is not allowed, accordingly, some of the conventional options common strategies may not be applicable with Islamic financial Options; complex strategies would require review from Islamic scholars on how to apply them.

Like conventional options, Islamic Options markets, need to be regulated by authorities, the burden of complying with the Islamic Sharea can be assumed by the Intermediaries/regulators/the market, who has the mechanisms and means to check the Sellers' position before registering Islamic Options Contracts.

The objective to calculate the Islamic Option value is to determine the consideration paid to the party exiting from a contract, by the replacing party; a key factor in determining the volume of investments market, when this value can be fairly calculated, investing in such instrument is regarded as feasible and rewarding.

Islamic financial options are real contracts, the specific profits of the contract are reasonably estimable along its life; Islamic financial options act like American Options in terms of the ability of option holder to exercise it any time during the agreed allowable period.

Valuation models applicable to calculate real financial instruments can be fairly used to calculate the market value of Islamic Financial Options.

1) (canceled)

2) (canceled)

3) (canceled)

4) (canceled)

5) (canceled)

6) (canceled)

7) (canceled)

8) (canceled)

9) (canceled)

10) A method for the implementation of a financial instrument comprising:
a standardized sale contract, being the financial instrument, wherein said contract obligates a buyer and a seller to settle the contract at a determined price, and on a determined agreed upon future price and termination date, and obligates the buyer to pay a percentage of said determined price upon signing the contract;
at least one underlying asset or a tradable instrument that is sold in said sale contract and is used to determine the sale price of said contract; and
wherein said method comprises the use of a specialized system and a server machine, and wherein said system resides on said server machine.

11) The method according to claim 10, wherein said financial instrument is traded on an official exchange markets and cleared by an official clearinghouse wherein said clearinghouse guarantees performance of the parties and execution of the contract conditions.

12) The method according to claim 10, wherein said financial instrument is used to hedge against the risk of investing in said underlying asset or tradable instrument.

13) A financial instrument, wherein said financial instrument is controlled and monitored via a computerized system managed by an official financial authority, wherein said financial instrument execution data is transmitted between a buyer and an exchange market and between a seller and an exchange market via a system of networked computers, contract execution data including information relating to the execution data of said financial instrument contract.

14) The financial instrument of claim 13, wherein said financial instrument execution data comprise the instructions from said financial instrument contract parties to exercise their rights according to said instrument contract.

15) The financial instrument according to claim 13 wherein said system comprises:
a processing unit used to access and operate the software,
a server unit including a memory storage device, that maintains a database which includes the results of effecting the instructed execution data and the value of said financial instrument and said underlying asset and the other financial data,
a database that includes memory storage device, that saves the results of execution data and the positions of the parties of said financial instrument and the underlying asset or tradable instrument data,
a software including an input interface for receiving execution data associated with said financial instrument and the underlying asset or tradable instrument value, wherein then generates reports and documentation based on said financial instrument parties' execution data, and
a program module, operated by said software and stored in the memory storage device for providing instructions to the processing unit; and wherein the processing unit, responsive to the instruction of the program module, implements a control logic responsive to the instructions relating to the financial instrument execution data, wherein it updates said financial instrument parties' rights and obligations and positions in relation to said financial instrument, wherein further implements an implementation logic that comply to said financial instrument objectives.

16) The financial instrument according to claim 15, wherein said software further implements a control logic to determine the value for said financial instrument comprising:
receiving financial data associated with said financial instrument contract,
receiving said financial instrument execution data from said instrument parties for the sale or purchase of said instrument,
receiving data associated with said underlying asset or tradable asset,
causing the computer to calculate the value of said financial instrument by applying a relevant pricing model utilizing the data associated with said financial instrument contract, said instrument parties sale or purchase transactions of said financial instrument, said data associated with the underlying asset or tradable instrument,
updating the database with said underlying asset data upon trading, and
causing the computer to take action based on the logic of implementing said financial instrument.

17) The financial instrument according to claim 15, wherein said program module is operative to enable transactions including a purchase, sale, or trade of said financial instrument.

18) The financial instrument according to claim 15, wherein said software further implements the execution data wherein it updates and determines the positions of said financial instrument parties associated with their rights in said financial instrument, and wherein said software generates associated reports and messages to the parties of said financial instrument.

19) The financial instrument according to claim 15, wherein said financial instrument is created, assigned a unique reference for the created instrument contract as an identifier, and registers the parties' positions data and register the timed rights conditions timeframes and terms of the instrument to oblige the parties implement, said software validates the non-clash of timed rights according to the contract type.

20) The financial instrument according to claim 15, wherein upon creating said financial Instrument contract said software implements a control logic to:
validate that no overlapping of the timeframes of said timed rights for each party, wherein the timeframe periods of tendering delivery by the party and the timed right to decline delivery by the other party, should not overlap,
validate that no overlapping of the periods of timed rights timeframes for each party, wherein the timeframe periods of the rights to postpone delivery of asset or remainder of price and the timeframe period of the rights to tender delivery of asset or remainder of price, should not overlap,
validate the ownership of the sold underlying assets or tradable instrument by the seller before creating said Financial Instrument contract,
validate the compatibility of said timed rights according to the implementation logic of said financial instrument, wherein specific rights should not be assigned to one single party to produce a meaningful instrument,
generate automatic message to advise on reviewing the dates if said overlapping periods occur and decline finalizing the registration of said financial instrument by authorities,
decline repetition of the use of expired timed rights according to the implementation logic of said financial instrument, wherein specific rights should not be exercised more than one time after they expire,
decline the execution of rights after the elapse of the timeframes of said timed rights for each party,
alert the authorities with the changes in said financial instrument parties due to assignment of rights during the instrument life, and changes in the parties' positions according to the requirements of the authorities,
allow customized notifications to said financial instrument parties based on their positions and based on the calculated value of said underlying asset or tradable instrument and the market value of said financial instrument,
register the timeframes of said timed rights and enable exercising the rights for each party according to the registered timeframes,
calculate the value of the underlying asset or tradable data sold in said financial instrument, based on which a relevant pricing model is applied to determine the financial instrument market value and alert the parties of their positions,
calculate commissions and fees of the managers and authorities, based on the execution data and volume of transactions,
in the end of said financial instrument contract term, calculate the final value of said financial instrument, and determines the value of said financial instrument based on the market data and relevant applicable pricing model, and
close said financial instrument position and issue statements of account of said financial instrument parties in the end of every day, and in the end of said financial instrument term.

21) The method according to claim 10 comprising a specific timed rights conditions for each of the buyer and the seller.

22) The method according to claim 21 wherein said timed rights conditions are conditions in said financial instrument contract, wherein said conditions enable each one of the parties the power to exercise specific agreed upon right during a specified timeframe as indicated in the instrument contract, said timeframe is an interval of time that begins on an agreed date must end at the maximum one day before the determined settlement date of said financial instrument contract, according to the agreement.

23) The method according to claim 10, wherein the contract must include a timed right condition that establishes the right for one or both parties to postpone delivery of assets and the remainder of the price to take place during an agreed upon timeframe that starts on an agreed date and at the maximum ends one day before the contract determined settlement date, and wherein said software registers and defines the agreed dates of delivery of the assets and price remainder, wherein said software registers execution data of delivery requests and decline of the requests, wherein said software accordingly updates the positions of the parties and issue notifications to the parties based on the executed rights and illustrating the up-to-date positions.

24) The method according to claim 10, said financial instrument contract grants the right for each party to assig or sell his roles and position to any third party unilaterally without the consent of the other party during an agreed upon timeframe that starts on an agreed date and at the maximum ends one day before the contract determined settlement date, wherein the instrument provides for the optional sale at a determinable non-zero value, said software computes the sale value of said instrument using suitable pricing algorithm, calculating the updated current parties' positions on the date of assignment, wherein said software further settles the exiting party position and transfers his roles and position to the new party, and update the contract parties' roles and positions, and generate notification messages to the parties based on the up-to-date positions.

25) The method according to claim 10, wherein said financial instrument includes a condition that establishes the right for only one of the parties to unilaterally revoke the contract during an agreed upon timeframe that starts on an agreed date and at the maximum ends one day before the contract determined settlement date, wherein said software registers the revocation, create a message to the other party to inform him of the revocation of the contract, calculate the values of the parties' positions, settle each party's position, and create a statement that defines the parties rights and obligations on the date of revocation, and request the parties to execute their roles based on the revocation, and declare the end of the contract based on the revocation, send a declaration to the authorities to inform them of the revocation of said financial instrument contract.

26) The method according to claim 10, wherein said financial instrument must include a condition that establishes the right for one or both of the parties to decline delivery of his part during an agreed upon timeframe that starts on an agreed date and at the maximum ends one day before the contract determined settlement date, wherein said software registers the request of the delivery and generate a message to inform the other party, and register the declining reply, and generate a message to the first party requesting delivery declaring the declined request, wherein said software registers the updated positions after the request and declined request, update the positions of the parties and issue a statement of the positions for the parties and inform the authorities of the action taken.

27) The method according to claim 10, wherein said financial instrument must include a condition that establishes the right for one or both of the parties to tender delivery of his part and unilaterally oblige the other party to deliver his part during an agreed upon timeframe that starts on an agreed date and at the maximum ends one day before the contract determined settlement date. Wherein said software captures the request to tender the delivery by the requesting party, and generates a message to the other party to inform him the request, and registers and opens the position of the party requested to deliver, wherein upon delivery said software closes the open position for that party and generate a report to indicate the new positions to the authorities, and create a statement that defines the parties rights and obligations, and declares the end of the contract, and declare the execution of said financial instrument contract.

28) The method according to claim 10, wherein said software validates the conditions and terms and compares the timed rights of each party to ensure no contradicting terms or rights are assigned to any of the parties according to the implementation logic of said financial instrument.

29) The method according to claim 10, wherein the purchaser pays a small part of the price, wherein the parties have the right to assign their positions unilaterally without the consent of the other party, and wherein the timed right to revoke the contract is assigned to the purchaser, and wherein the timed right to decline delivery is assigned to the seller, and wherein the timed right to tender price and enforce the delivery assigned to the purchaser, said financial instrument performs as a call option, wherein the purchaser revokes said financial instrument contract is letting the call option expire, and whereas non-revocation of said financial instrument contract is exercising the call option, wherein further, said software assigns the rights as designated, restricts the other party from contrary actions, and enforce the contract in the last day if option are not exercised.

30) The method according to claim 10, wherein the purchaser pays a small part of the price, wherein the parties have the right to assign their positions unilaterally without the consent of the other party, and wherein the timed right to revoke the contract is assigned to the seller, and wherein the timed right to decline delivery is assigned to the seller, and wherein the timed right to tender delivery is assigned to the seller, said financial instrument performs as put option, wherein the seller revokes the contract is letting the put option expire, and whereas non-revocation of the contract is exercising the put option, wherein further, said software assigns the rights as designated, restricts the other party from contrary actions, and enforce the contract in the last day if option are not exercised.

31) The financial instrument according to claim 15 wherein upon the termination of said financial instrument contract, settles the positions of said financial instrument contract parties and generates a message that defines the parties' final positions, and rights and obligations as on the date of the last day of the contract, and register the termination of said financial instrument contract to the authorities.
